(19) United States
(12) Patent Application Publication
(10) Pub. No.: US 2013/0186920 A1
(43) Pub. Date: Jul. 25, 2013

(54) FEED RATE CONTROLLER FOR GRANULATED MATERIALS

(71) Applicants: Christopher W. Strock, Kennebunk, ME (US); George H. Reynolds, Sanford, ME (US)

(72) Inventors: Christopher W. Strock, Kennebunk, ME (US); George H. Reynolds, Sanford, ME (US)

(73) Assignee: UNITED TECHNOLOGIES CORPORATION, Hartford, CT (US)

(21) Appl. No.: 13/355,616

(22) Filed: Jan. 23, 2012

(51) Int. Cl. B05B 7/00

(52) U.S. Cl. 222/630

(57) ABSTRACT

The flow of granulated materials from a supply hopper to a transport tube is controlled. A material feed friction tube is positioned to receive material from the hopper. The friction tube receives material independent from hopper pressure and the material moves to an orifice. The orifice discharges material to a pickup tube from the orifice and includes a transfer tube for receiving material from the pickup tube. The pickup tube has a source of carrier gas sufficient to move the material into the transfer tube for further use.

### BACKGROUND

A wide variety of materials in small particle size are transferred from hoppers to a location where the materials are to be used. Powders as small as dust or chemical powders to as large as pellets or corn, by way of example, are taken from hoppers using devices that are gravity fed to introduce the material into a gas flow for the intended use of the material.

Feed rate control, such as for example, of grit for suction grit blast applications suffers from variability due to changing hopper loading and dust collector vacuum. Variations in these parameters cause the flow of grit through an orifice plate or into other suction pickup devices to fluctuate.

To achieve a constant flow rate, which is highly desirable, the operator must frequently adjust orifice and suction settings. With only loose observational process feedback available to operators, these adjustments are made infrequently and somewhat arbitrarily. This makes locking down process parameters impossible.

It is also a significant problem if the process has to be stopped in order to reload the hopper. It is also a problem if changes in pressures, flow rates, and supply volumes are adjusted arbitrarily based on observations after a change in flow has occurred.

It would be a great advantage in suction grit blast applications if control of grit flow could be achieved to accommodate changes in the process, particularly in compensating for grit material head pressure in the grit supply.

### SUMMARY

A device, system and method for controlling feed rate consistency in the flow of granulated materials is provided. Granulated materials are transferred from a supply hopper to a material feed friction tube. The tube has a predetermined diameter and length leading to a discharge end. The length of the tube is sufficient to provide a head pressure from the solid particles that is independent of hopper loading. When the hopper is open, which allows additional material to be added to the hopper as needed, the head pressure on the material in the friction tube is dissipated by friction between particles and the walls of the friction tube, making the pressure at the discharge end of the friction tube independent of the head pressure of the material in the hopper. The length to diameter ratio is sufficiently high to eliminate the head pressure. An effective length to diameter ratio, L/C, is equal to or greater than four.

Material is then discharged from the tube through an orifice having a smaller diameter than the diameter of the friction tube. A pickup tube is positioned to receive material from the orifice and move the material into a transfer tube using a source of carrier gas.

The pickup tube has a diameter large enough to accept all the material discharged from the orifice, and the transfer tube has a diameter equal to or less than that of the pickup tube.

In one embodiment, the orifice diameter can be adjusted to insure smooth transport of the solid material. A control pressure source of gas can be provided for adjusting the pressure at the orifice to approximately the pressure of the source of carrier gas in the pickup tube. A vibrator near the bottom of the hopper can be used to help fluidize the powder and assist the powder in powder entry into the friction tube.

### BRIEF DESCRIPTION OF THE DRAWINGS

FIG. 1 is a perspective view of one embodiment of the invention.

FIG. 2 is a perspective view of a second embodiment of the invention.

### DETAILED DESCRIPTION

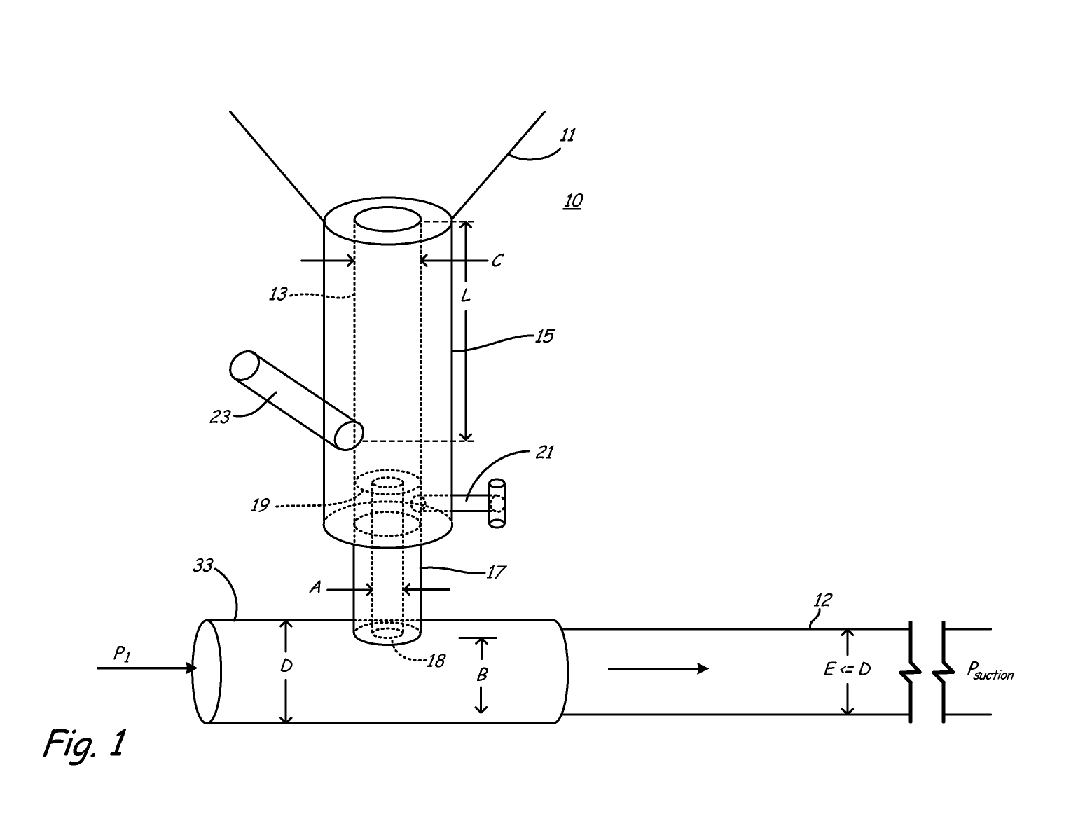

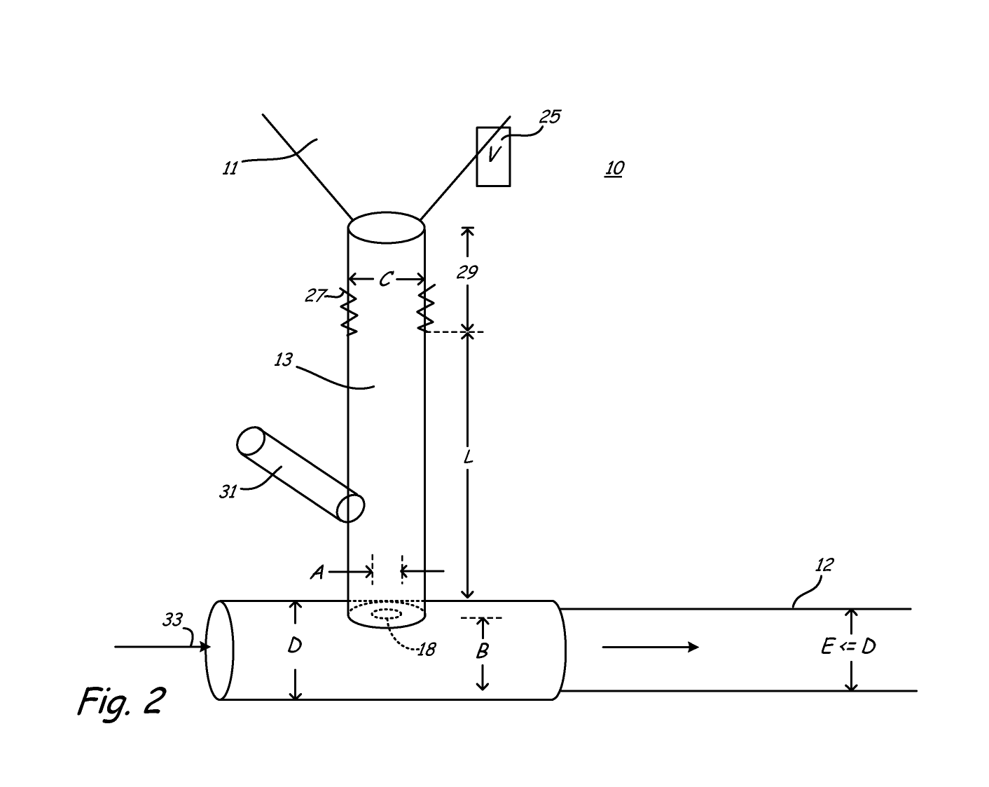

Feed rate controller 10 controls flow of granulated material from hopper 11 to transport tube 12, as seen in both FIG. 1 and FIG. 2. The material may be any granulated material, including but not limited to powder, pellets, grit, corn, granulated crystals and the like. Controller 10 is particularly suited for feed rate consistency control of grit for suction blast applications. Hopper 11 may be closed or open, with the latter permitting addition of more material while the device is being used.

Controller 10 includes material feed friction tube 13 that is positioned to receive material from hopper 11. Friction tube 13 may include an outer wall 15 in FIG. 1 to support friction tube inner wall 13. Friction tube 13 has a length L from the point where the granulated material enters tube 13 to the point where head pressure reduced by inter material friction, discussed below, ends. Friction tube 13 has a diameter C. Length L is greater than diameter C and must be sufficiently long to provide friction forces from the solid particles within friction tube 13 that is greater than the head pressure caused by material in hopper 11. Friction tube 13 negates the head pressure from hopper 11 by the friction forces when the particles of granulated materials rub against the side walls of friction tube 13 and against each other. Friction tube 13 length L to diameter C ratio is sufficiently high to eliminate any effect of head pressure on the orifice flow rate. Thus L/C>=4.

At the bottom of friction tube 13, orifice tube or plate 17 is positioned to receive material from the discharge end 19 of friction tube 13. FIG. 1 shows device 10 in a passive mode, where friction tube 13 is vented to atmospheric pressure above an orifice tube 17 having an orifice 18. The diameter A of orifice 18 is sized to result in smooth transport of the granulated material caused by suction air flow. Orifice tube 17 is held in place with set screw 21. Pressure above orifice tube 17 is vented to the atmosphere via vent 23 to provide the passive mode described above. When hopper 11 is itself vented to atmospheric pressure 3, vent 23 is not required.

Particles exit friction tube 13 into orifice tube 17 and are controlled so that flow of particles is maintained regardless of the quantity of particles in hopper 11. Orifice 18 diameter A is smaller than friction tube 13 diameter C. Particles flow down into pick up tube 33, which has a diameter D that is larger than material height B in order to start airflow without clogging.

Height B is high enough to prevent material from piling up and influencing flow through orifice 18. Carrier gas, such as nitrogen, has a pressure P₁ and enters pickup tube 33 to transport the particles into transport tube 12, which has a diameter E that is less than or equal to pickup tube diameter D. The velocity of the transport tube 12 gas is greater than or equal to the pickup tube 33 velocity.

FIG. 2 illustrates a second embodiment in which a vibrator 25 is connected to hopper 11 to cause powder to fluidize. Vibrator 25 assists the powder entering the smaller vertical friction tube 13 without clumping or bridging at the entrance to friction tube 13. Partially down friction tube 13 is a vibration isolator 27 which stops the powder from being fluidized in friction tube 13 in order to allow frictional forces between particles and between particles and friction tube 13 walls. Thus length L is the length of friction tube 13 in which friction forces interact with each other and tube 13 walls to provide the needed head pressure. Length 29 isolates the fluidized powder flow from friction tube 13 and is equal to or greater than the distance the granulated material requires to transition from fluidized by vibration to friction dominated flow through isolator 27.

In FIG. 2, the powder or granulated material is subjected to a control pressure from pressure tube 31. The head pressure from the particles in friction tube 13 over length L is greater that the difference between control pressure in tube 31 and pressure in hopper 11. Orifice 18 has a diameter also sized to result in smooth transport of the granulated material at the control pressure and the desired flow rate.

Granulated material exiting orifice 18 into pick up tube 33 does not pile up and influence the flow through the orifice because carrier gas flow rate is sufficient to prevent that from occurring. Carrier gas flow in transport tube 12 is greater than or equal to pickup tube 33 velocity. Again, friction tube 13 length L to diameter C ratio is sufficiently high to eliminate any effect of hopper head pressure on the orifice flow rate. Thus L/C>=4.

Hopper 11 can be open, for the addition of more granulated material during operation as long as the head pressure over length L is greater than the delta P between the control pressure in tube 31 and atmospheric pressure.

When carrier gas flow is stopped, granulated material exits orifice 18 into pick up tube 33 and piles up to stop the flow through the orifice. Flow can then be re-established by resuming gas flow. This can be achieved smoothly by maintaining height B at a sufficiently small fraction of the diameter of pickup tube diameter D to allow the initiation of gas flow around the piled up granular material.

In both embodiments, the powder or granulated material exits transfer tube 12 as intended. The present invention has been found to be effective in controlling the flow of particles from a hopper to an end use, such as grit blasting of objects such as metal parts.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A control device for controlling flow of granulated materials from a hopper to a transfer tube, the control device comprising:
a material feed friction tube positioned to receive granulated material from the hopper, the friction tube having an upper inlet end and a lower discharge end, the friction tube having a diameter and length, the length being larger than the diameter and sized to cause the head pressure from the granulated material in the hopper to be dissipated by particles of granulated material rubbing against each other and the side walls of the friction tube; and
an orifice having a diameter and position for receiving material from the discharge end of the friction tube, the orifice being positioned to discharge material in a downward direction.

2. The control device of claim 1, which further includes a pickup tube positioned to receive material from the orifice to a transfer tube for receiving material from the pickup tube, the pickup tube having a source of carrier gas sufficient to move the material into the transfer tube.

3. The control device of claim 2, wherein the pickup tube has a gas flow rate and a diameter sized to prevent granulated material from piling up when discharged from the orifice tube.

4. The control device of claim 3, wherein the transport tube has a diameter less than the diameter of the pickup tube.

5. The control device of claim 1, wherein the friction tube includes a vibrator positioned proximate the inlet of the material feed friction tube from the supply hopper to cause granulated material to enter the friction tube as fluidized particles, the vibrator further being adapted to isolate the fluidized particles from a portion of the friction tube to cause the material to have frictional forces between the material and the wall of the material feed friction tube, the portion of the friction tube having frictional forces being of sufficient length to cause the granulated material to dissipate head pressure from particles of granulated material rubbing against each other and the side walls of the friction tube.

6. The control device of claim 1, wherein the material feed friction tube includes a control pressure source of gas for adjusting the pressure at the orifice to approximate the pressure of the source of carrier gas in the pickup tube.

7. A system for controlling flow of granulated materials, comprising:
a granulated material supply hopper having a quantity of granulated material therein, the hopper having an opening for receiving more granulated material;
a material feed friction tube positioned to receive granulated material from the hopper, the friction tube having an upper inlet end and a lower discharge end, the friction tube having a diameter and length of at least a portion of its total length, the length being larger than the diameter and sized to cause the granulated material to create a pressure from particles of granulated material rubbing against each other and the side walls of the friction tube;
an orifice having a predetermined diameter and position for receiving material from the discharge end of the friction tube, the orifice being positioned to discharge material in a downward direction;
a pickup tube positioned to receive material from the orifice, the pickup tube having a diameter sized to accept all the material discharged from the orifice tube, the pickup tube further having a source of carrier gas sufficient to move the material away from the orifice tube; and
a transfer tube positioned to receive material from the pickup tube, the transfer tube having a diameter less than or equal to the diameter of the pickup tube.

8. The system of claim 7, wherein the friction tube provides a head pressure on material in the friction tube that is greater than the pressure of the material in the hopper.

9. The system of claim 7, wherein the friction tube includes a vibrator positioned proximate the inlet end of the material feed friction tube from the supply hopper to cause granulated material to enter the friction tube as fluidized particles, the vibrator further being adapted to isolate the fluidized particles in the friction tube to cause the material to have frictional forces between the material and the feed friction tube, the portion of the friction tube having frictional forces being of sufficient length to cause the granulated material to create a pressure from particles of granulated material rubbing against each other and the friction tube.

10. The system of claim 7, wherein the pickup tube has a diameter sized to prevent granulated material from piling up when discharged from the orifice tube.

11. The system of claim 7, wherein the transport tube has a diameter less than the diameter of the pickup tube.

12. A method for controlling the flow of granulated materials, comprising:
supplying a granulated material in a supply hopper;
delivering material from the hopper into an inlet at an upper end of a material feed friction tube positioned to receive material from the hopper;
discharging material from an orifice at the lower end of the friction tube into a pickup tube positioned to receive material from the orifice; and
transferring the material from the pickup tube to a transfer tube, the pickup tube having a source of carrier gas sufficient to move the material into the transfer tube for further use.

13. The method of claim 12, wherein the orifice is formed in a tube positioned in the friction tube.

14. The method of claim 12, wherein the friction tube provides a head pressure on material in the friction tube that is greater than the pressure of the material in the hopper.

15. The method of claim 12, wherein the pickup tube has a diameter sized to prevent granulated material from piling up when discharged from the orifice tube.

16. The method of claim 12, wherein the orifice includes a holding device for adjusting the orifice tube diameter.

17. The method of claim 12, wherein the material feed friction tube includes a controlled pressure source of gas for adjusting the pressure at the orifice to approximate the pressure of the source of carrier gas in the pickup tube.

18. The method of claim 17, wherein the controlled pressure source of gas is introduced at an angle with respect to the direction of material flow in the material feed friction tube.

19. The method of claim 12, wherein a vibrator is positioned proximate the inlet of the material feed friction tube from the supply hopper to cause granulated material to enter the friction tube as fluidized particles, the vibrator further being adapted to isolate the fluidized particles in the friction tube to cause the material to have frictional forces between the material and the material feed friction tube, the portion of the friction tube having frictional forces being of sufficient length to cause the granulated material to create a pressure from particles of granulated material rubbing against each other and the friction tube.

20. The method of claim 19, wherein the orifice is positioned at a bottom of the friction tube.
